(19) United States
(12) Patent Application Publication
(10) Pub. No.: US 2019/0197817 A1
(43) Pub. Date: Jun. 27, 2019

(54) MEDICINE SUPPLY APPARATUS

(71) Applicant: Takazono Technology Incorporated, Hirakata-shi, Osaka (JP)

(72) Inventors: Takayuki Fujii, Hirakata-shi, Osaka (JP); Katsuhiro Hirai, Hirakata-shi, Osaka (JP)

(73) Assignee: Takazono Technology Incorporated, Hirakata-shi, Osaka (JP)

(21) Appl. No.: 16/331,252

(22) PCT Filed: Sep. 1, 2017
(86) PCT No.: PCT/JP2017/031607

§ 371 Date: Mar. 7, 2019

(30) Foreign Application Priority Data
Sep. 14, 2016 (JP) 2016-179792

(51) Int. Cl. G07F 17/00; G07F 11/62; A61J 7/00

(52) U.S. Cl. CPC G07F 17/0092; G07F 11/44; A61J 7/0084; G07F 11/62

(57) ABSTRACT

A medicine supply apparatus includes a housing, first to nth (n is an integer of 2 or more) segments which are arranged in order in the housing along the circumference direction so as to surround a center line, a drive unit configured to rotate an aggregate of the first to nth segments about the center line, an input unit configured to receive an instruction, and a control unit configured to control the drive unit. The housing is provided with a cleaning position that allows at least one of the first to nth segments to be cleaned. The input unit may receive an instruction for selecting one of the first to nth segments. The control unit causes the drive unit to locate the selected segment at the cleaning position on the basis of the instruction for selecting one of the first to nth segments.

### TECHNICAL FIELD

The present invention relates to a medicine supply apparatus.

### BACKGROUND ART

Japanese Patent Laying-open No. 9-201399 (PTL 1) describes an apparatus for storing and dispensing medicines. As an example of the apparatus, PTL 1 describes a configuration in which feeder columns are annularly arranged on an inner annular plate and an outer annular plate, both of which are pivotally supported. Each feeder column is constituted by a plurality of medicine feeders stacked vertically, and each medicine feeder is configured to accommodate therein a medicine. A medicine guide passage is provided in each feeder column. A hopper is provided below the annular plate, and a packaging device is provided below the hopper.

### CITATION LIST

### Patent Literature

PTL 1: Japanese Patent Laying-Open No. 9-201399

### SUMMARY OF INVENTION

### Technical Problem

In a medicine supply apparatus, a plurality of medicine cassettes for storing medicines to be supplied are collectively arranged to have a cylindrical shape and are pivotally supported, and such structure is called as a “drum”. When a user attempts to clean a desired part of the drum, the part may not face to the front. If the part is not facing to the front, the user needs to rotate the drum and wait until the part is rotated to the front. In the conventional medicine supply apparatus, the rotation angle and the direction of rotation of the drum are restricted, and thus, rotating the desired part to the front for cleaning may not be performed efficiently, which makes the waiting time longer.

An object of the present invention is to provide a medicine supply apparatus capable of minimizing the waiting time for rotating a drum for cleaning.

### Solution to Problem

To attain the object mentioned above, the medicine supply apparatus according to the present invention includes a housing, first to nth (n is an integer of 2 or more) segments which are arranged in order in the housing along the circumferential direction so as to surround a center line extending in the vertical direction, a drive unit configured to rotate an aggregate of the first to nth segments about the center line, an input unit configured to receive an instruction, and a control unit configured to control the drive unit. The housing is provided with a cleaning position that allows at least one of the first to nth segments to be cleaned. Each of the first to nth segments includes a plurality of medicine accommodation units configured to accommodate therein a medicine. The input unit is configured to receive an instruction for selecting one of the first to nth segments. The control unit is configured to cause the drive unit to operate so as to locate the selected segment at the cleaning position on the basis of the instruction for selecting one of the first to nth segments.

### Advantageous Effects of Invention

According to the present invention, it is possible to minimize the waiting time for rotating the drum for cleaning.

### BRIEF DESCRIPTION OF DRAWINGS

FIG. 1 is a perspective view illustrating a medicine supply apparatus according to a first embodiment of the present invention;

FIG. 2 is a perspective view illustrating the medicine supply apparatus according to the first embodiment of the present invention when one door is opened;

FIG. 3 is a perspective view illustrating the medicine supply apparatus according to the first embodiment of the present invention when the doors, the side plates and the like are removed;

FIG. 4 is a schematic perspective view illustrating a drum provided in the medicine supply apparatus according to the first embodiment of the present invention;

FIG. 5 is a first perspective view illustrating a segment provided in the medicine supply apparatus according to the first embodiment of the present invention;

FIG. 6 is a second perspective view illustrating a segment provided in the medicine supply apparatus according to the first embodiment of the present invention;

FIG. 7 is a perspective view illustrating the medicine supply apparatus according to the first embodiment of the present invention when one door is opened and one segment is drawn out;

FIG. 8 is a partial cross-sectional view illustrating the medicine supply apparatus according to the first embodiment of the present invention when one door is opened and one segment is drawn out;

FIG. 9 is a partially enlarged perspective view illustrating a portion in the vicinity of a bottom of the drum in the medicine supply apparatus according to the first embodiment of the present invention;

FIG. 10 is a schematic view illustrating the medicine supply apparatus according to the first embodiment of the present invention;

FIG. 11 is a schematic view illustrating a first state to be taken by the drum of the medicine supply apparatus according to the first embodiment of the present invention;

FIG. 12 is a schematic view illustrating a second state to be taken by the drum of the medicine supply apparatus according to the first embodiment of the present invention;

FIG. 13 is a schematic view illustrating a third state to be taken by the drum of the medicine supply apparatus according to the first embodiment of the present invention;

FIG. 14 is a schematic view illustrating a fourth state to be taken by the drum of the medicine supply apparatus according to the first embodiment of the present invention;

FIG. 15 is a front view illustrating a first state of an input unit of the medicine supply apparatus according to the first embodiment of the present invention; and

FIG. 16 is a front view illustrating a second state of the input unit of the medicine supply apparatus according to the first embodiment of the present invention.

### DESCRIPTION OF EMBODIMENTS

### First Embodiment

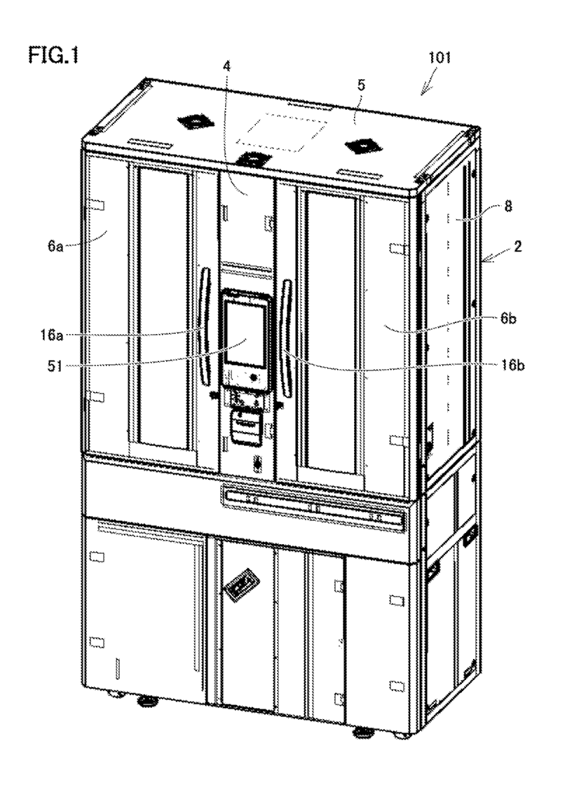

With reference to FIGS. 1 to 16, a medicine supply apparatus according to a first embodiment of the present invention will be described.

The medicine supply apparatus 101 according to the present embodiment is configured to supply medicines based on a prescription. The prescription is handed by a doctor to a patient. The prescription is written with prescription information. The prescription information contains medicine information. The medicine information includes the name, quantity, usage and dosage of a medicine. The medicine supply apparatus 101 supplies a solid medicine as the medicine. As examples of a solid medicine, a tablet, a pill, a capsule and the like may be given. The medicine supply apparatus 101 may be included in a medicine packing apparatus configured to pack medicines according to a prescription.

FIG. 1 illustrates an outer appearance of the medicine supply apparatus 101 according to the present embodiment. The medicine supply apparatus 101 includes a housing 2. The housing 2 includes a front plate 4, a side plate 8, and a top plate 5. On the front face of the housing 2, a door 6a, the front plate 4 and a door 6b are arranged in this order. The front plate 4 is disposed at the center of the front face of the housing 2 so as to extend in the vertical direction, and the doors 6a and 6b are symmetrically provided at the both sides of the front plate 4. The door 6a is provided with a handle 16a, and the door 6b is provided with a handle 6b. Thereby, the user may use the handles 16a, 16b to open and close the doors 6a, 6b. The medicine supply apparatus 101 includes an input unit 51 provided on the front face. The input unit 51 is disposed on the front plate 4 as illustrated in FIG. 1, for example. The side plate 8 is arranged on both side faces of the housing 2.

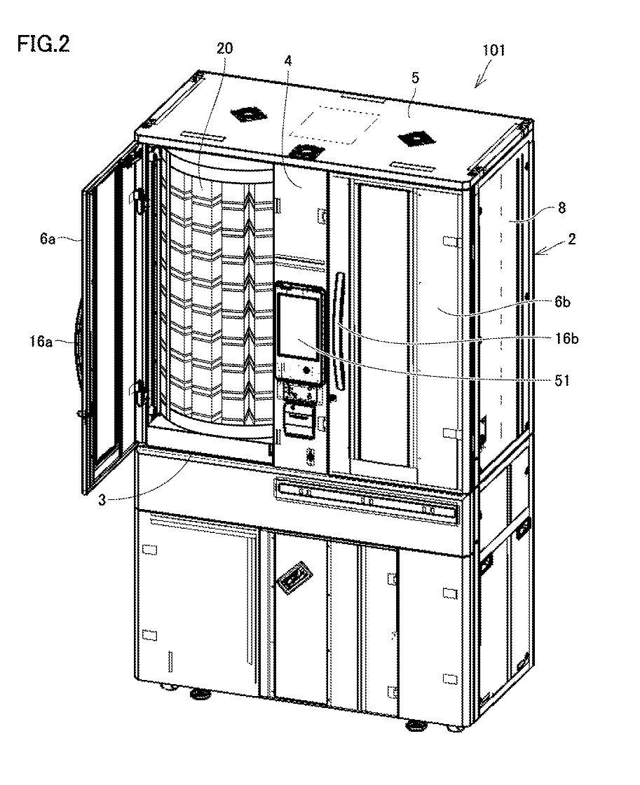

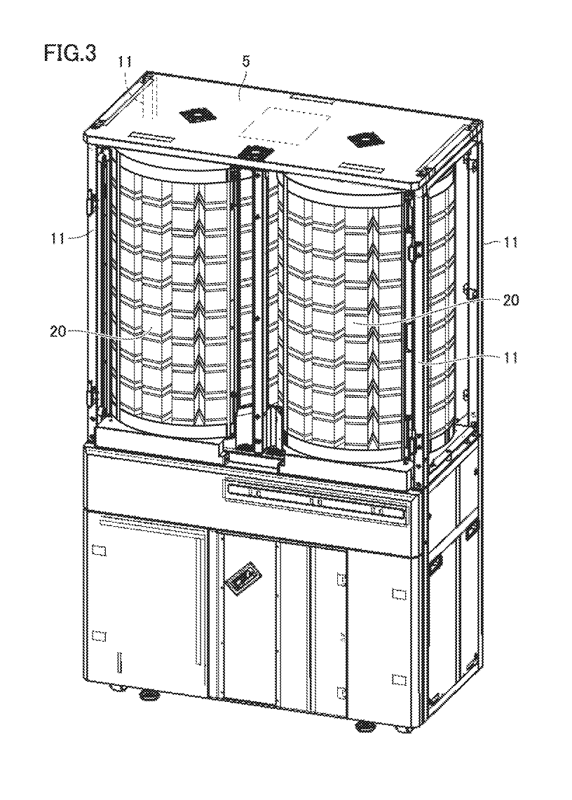

FIG. 2 illustrates a state in which the door 6a of the medicine supply apparatus 101 is opened. When the door 6a is opened, a drum 20 is visible through an opening 3. FIG. 3 illustrates a state in which the doors 6a and 6b, the front plate 4 and the side plate 8 of the housing 2 are removed. The top plate 5 is supported by a plurality of pillars 11 extending in the vertical direction. At least four of the plurality of pillars 11 are arranged to support the top plate 5 at four corners thereof. Two drums 20 are arranged below the top plate 5. Each drum 20 is individually and pivotally installed. In the present embodiment, the medicine supply apparatus 101 illustrated as an example is provided with two drums 20, but the number of drums provided in the medicine supply apparatus is not limited to two. The number of drums provided in the medicine supply apparatus may be one or three or more.

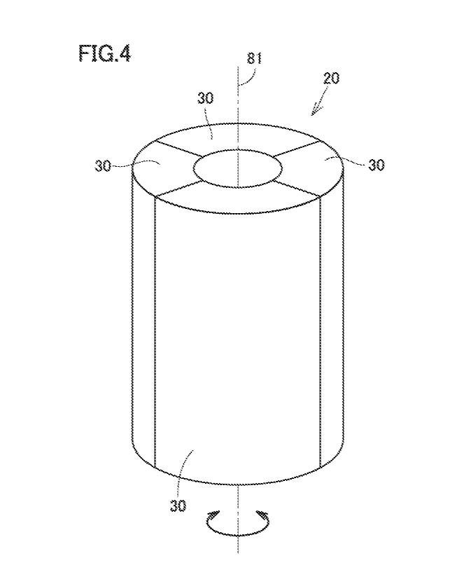

The structure of the drum 20 is schematically illustrated in FIG. 4. The drum 20 is constituted by four segments 30 and has a cylindrical shape. The drum 20 is pivotally supported around a center line 81 extending in the vertical direction. In the present embodiment, the drum 20 is constituted by a total of four segments divided by 90° but not limited thereto, the drum may be constituted by n segments, wherein n is an integer of 2 or more. The center angle per segment may change in accordance with the value of n. The center angle per segment is equal to the angle obtained by equally dividing 360° by n, for example. The drum may include n segments and may further include a mechanism configured to join these segments together or a mechanism configured to hold these segments.

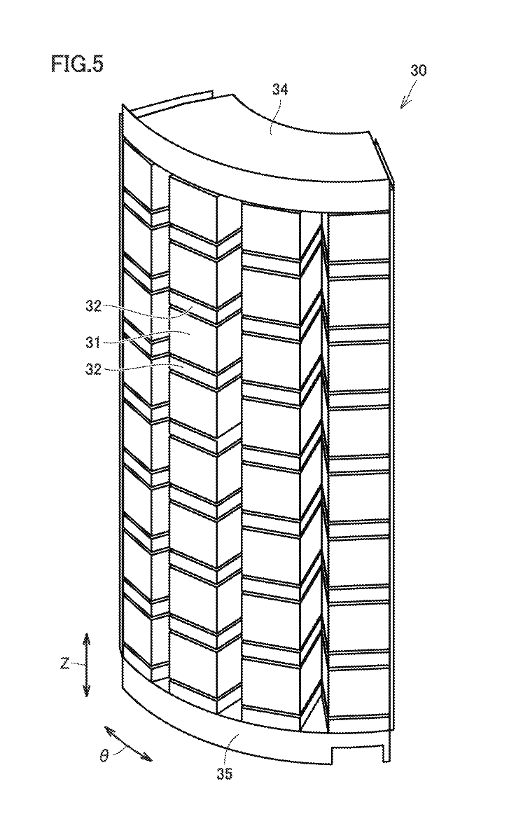

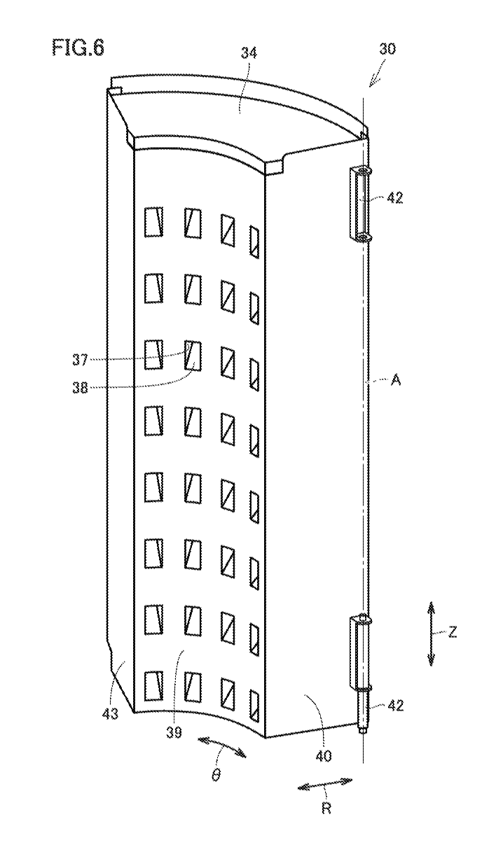

FIG. 5 illustrates one segment 30 drawn out from the drum. The segment 30 includes an upper portion 34, a lower portion 35, and a plurality of medicine accommodation units 31 arranged between the upper portion 34 and the lower portion 35. Each medicine accommodation unit 31 is supported by a support member 32. Each of the plurality of medicine accommodation units 31 is accommodated with a plurality of medicines. In other words, when the medicine is a tablet medicine, for example, plural tablets are accommodated in one medicine accommodation unit 31. In general, the plurality of medicine accommodation units 31 are configured in such a manner that the same type of medicine is accommodated in one medicine accommodation unit 31, and different types of medicines are accommodated in different medicine accommodation units 31, respectively. However, for those medicines that are frequently used, the same type of medicine may be accommodated in more than one medicine accommodation unit 31. Each of the plurality of medicine accommodation units 31 may supply the medicine accommodated therein. The medicine accommodation unit 31 may be a cassette capable of accommodating therein a medicine. Each medicine accommodation unit 31 may be provided with a handle to be held by the user to attach or detach the medicine accommodation unit. FIG. 6 illustrates the segment 30 when viewed from the opposite side. The segment 30 has an inner peripheral surface 39. The inner peripheral surface 39 may be a curved surface. The inner peripheral surface 39 is provided with a radial passage 37 that opens toward each of the medicine accommodation units 31. The radial passage 37 extends with a component in the radial direction R. The inner surface of each radial passage 37 is provided with an inclined surface 38 that inclines relative to the axial direction Z. The segment 30 has two side faces 40 and 43. The segment 30 is provided with two shaft supports 42 at one edge of the side face 40. The two shaft supports 42 are aligned in the vertical direction along a common axis A.

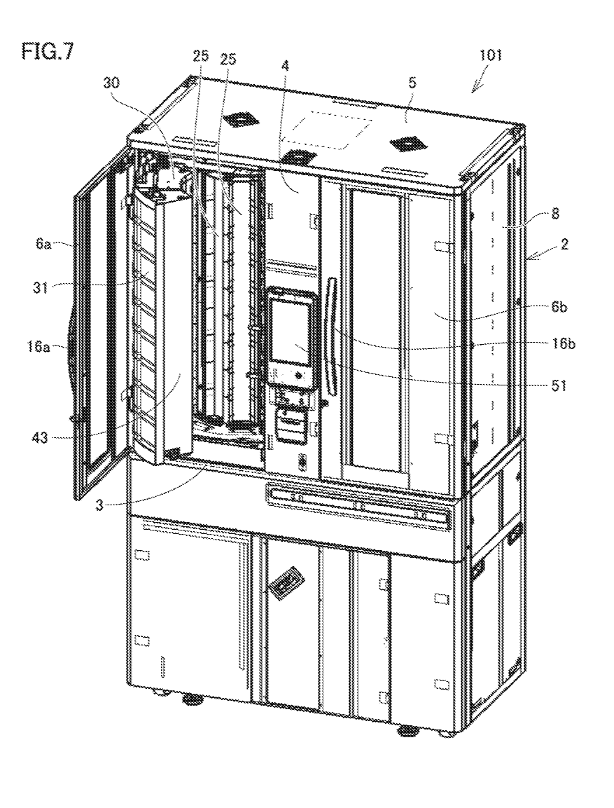

FIGS. 7 and 8 illustrate the medicine supply apparatus 101 when the door 6a is opened and one segment 30 is drawn out from the opening 3. In FIG. 8, the door 6a is not illustrated. The segment 30 is pivotally supported about the axis A by the shaft support 42. Thereby, the segment 30 may be rotated to the outside of the drum 20. When a user performs cleaning, repair, inspection or the like on the drum 20, the segment 30 may be drawn out. FIG. 7 illustrates a state when one segment 30 is drawn out, an axial passage 25 provided inside the drum 20 is visible. The axial passage 25 is configured as a passage through which the medicine discharged from the radial passage 37 (see FIG. 6) drops. As illustrated in FIG. 8, a plurality of axial passages 25 are annularly arranged at the inner side of the drum 20. Each axial passage 25 extends in a direction perpendicular to the paper surface of FIG. 8.

However, the medicine supply apparatus illustrated in FIG. 7 and FIG. 8 is merely an example, and the rotation of the segment 30 is not limited to the described manner. The segment may not be rotated in the described manner, it may be operated with respect to the drum 20 by hand or a tool inserted through the opening 3.

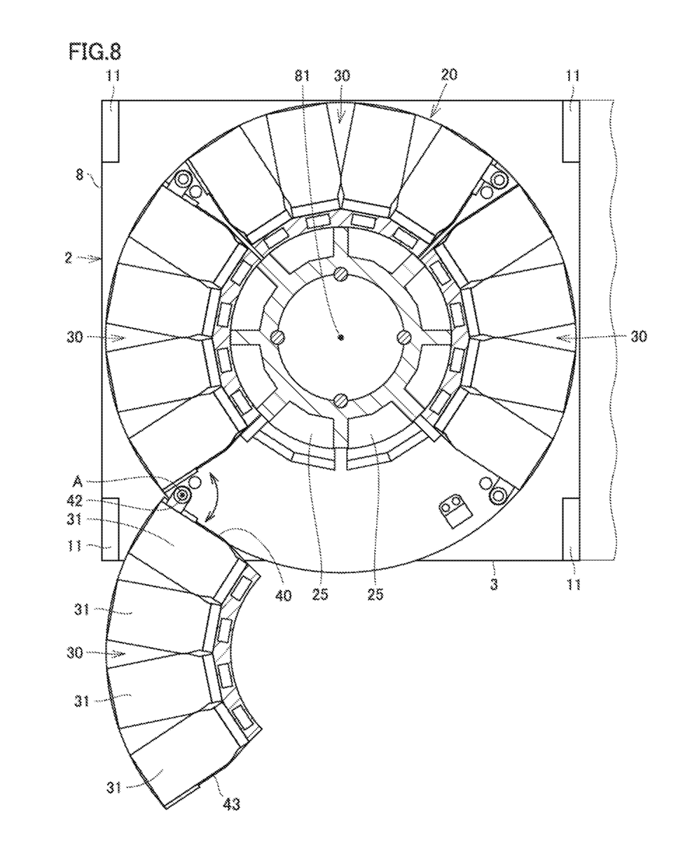

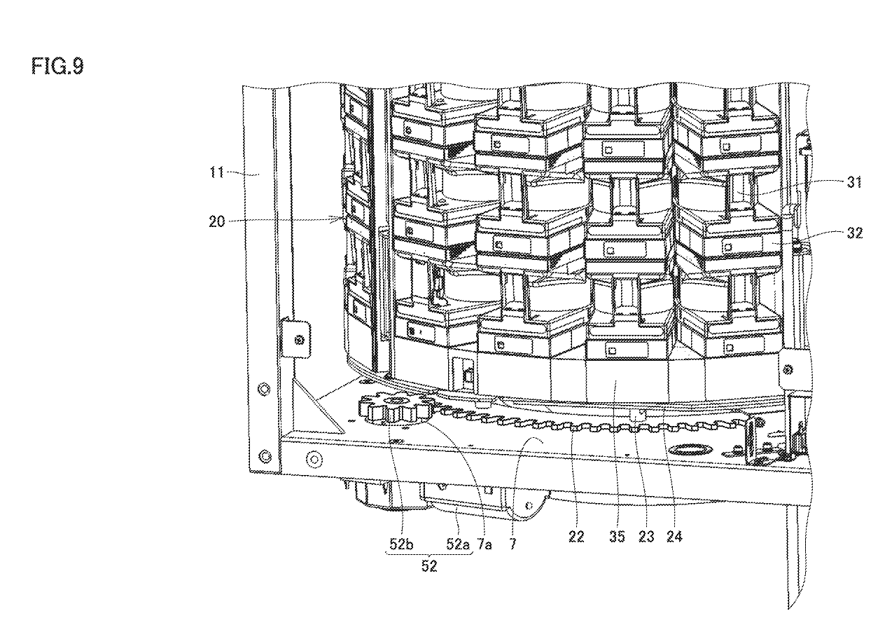

FIG. 9 illustrates an enlarged portion of the medicine supply apparatus 101. In FIG. 9, a bottom of the drum 20 and the structural components in the vicinity of the bottom are illustrated. A space for accommodating the drum 20 is provided in the upper half of the internal space of the housing 2, and a plate 7 is provided as the floor of the space. The plate 7 is provided with an opening 7a. A drive unit 52 is disposed to sandwich the plate 7 via the opening 7a. The drive unit 52 includes a motor 52a and a gear 52b. The bottom of the drum 20 is supported by a substantially circular bottom plate 24 from the lower side. The lower surface of the bottom plate 24 is provided with an annular member 22. The outer periphery of the annular member 22 is formed with a gear. The annular member 22 and the bottom plate 24 are connected to each other by a plurality of connection members 23. The motor 52a disposed on the lower surface of the plate 7 is configured to rotate the gear 52b disposed on the upper surface of the plate 7. The gear 52b meshes with the gear formed on the outer periphery of the annular member 22, whereby the annular member 22 rotates as a slave of the gear 52b. Thus, the drum 20 is rotated about the center line 81 as illustrated in FIG. 4.

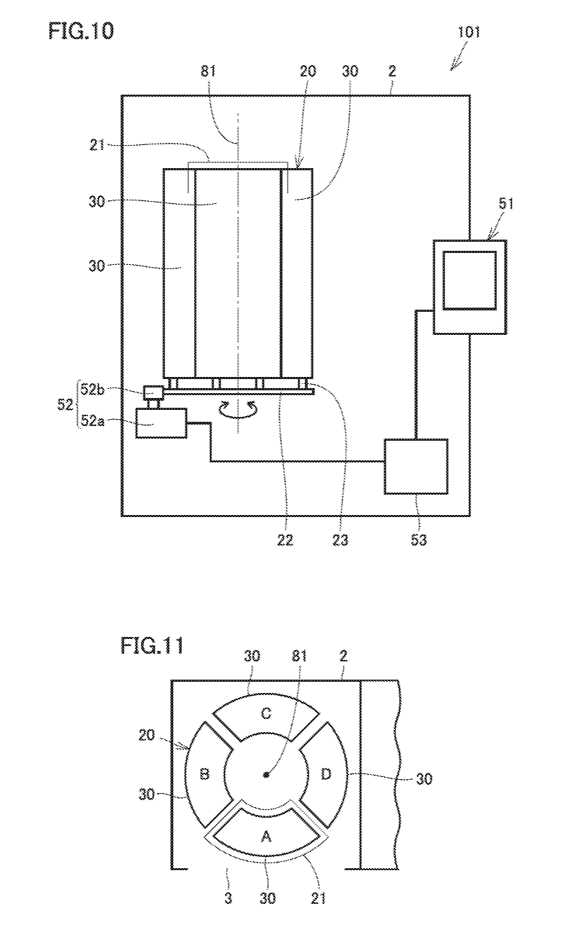

As illustrated in FIG. 10, the medicine supply apparatus 101 includes a control unit 53. The control unit 53 is configured to control the operation of the drive unit 52 based on an instruction received by the input unit 51. For convenience of explanation, only one drum 20 is illustrated in FIG. 10, but the number of drums 20 may be two or more. In the case where a plurality of drums 20 are present, the drive unit 52 may be provided for each drum 20 separately. In the case where a plurality of drive units are provided, the plurality of drive units may be controlled collectively by one control unit 53 or may be controlled separately by a plurality of control units.

When the four segments 30 included in one drum 20 are denoted by A, B, C and D, the drum 20 may assume four positions illustrated respectively in FIGS. 11 to 14. In the present embodiment, the description will be carried out on the left drum 20 of the two drums 20 housed in the housing 2. A cleaning position 21 is provided close to the opening 3 of the housing 2. Each of the four segments 30 may be located at the cleaning position 21 by rotating the drum 20. The cleaning operation or the like may be performed through the opening 3 of the housing 2. In order to perform the cleaning operation or the like on a particular segment 30, it is required to locate the segment 30 at the cleaning position 21. Even when the segment 30 is configured to be drawn out by rotating the drum about the axis A as described above, it is required to temporarily locate the segment 30 at the cleaning position 21.

The input unit 51 may be provided with a display 51a having a touch panel. The input unit 51 may display buttons on the display 51a. When the user presses a button displayed on the display 51a, the input unit 51 receives an instruction from the user via the touch panel. The input unit is not limited to the exemplified touch panel system, it may be a device including an operation panel provided with physical buttons. For example, the input unit may a device that includes a screen and an input element such as a keyboard, a mouse or the like. The input unit may be a personal computer, a tablet terminal or the like. The input unit may be removable from the housing 2. The input unit is not limited to receiving instructions from a human user, it may be configured to receive instructions from any device. The input unit may also be configured to receive external instructions via electrical signals, radio waves, light signals or the like.

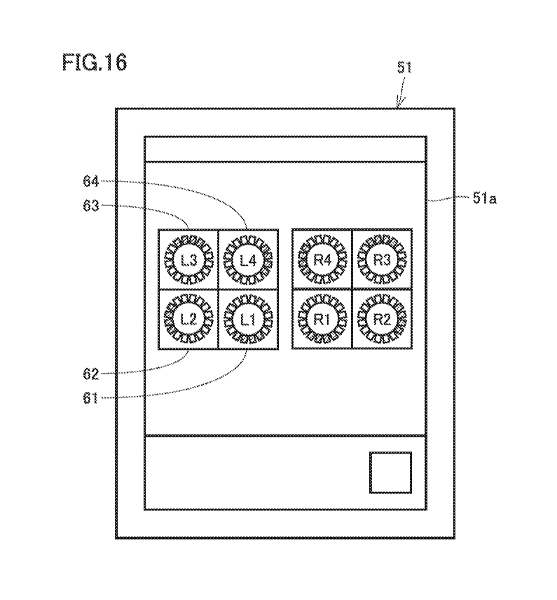

In the present embodiment, the description will be carried out by assuming that the input unit 51 is provided with the display 51a having a touch panel. An example of the input unit 51 is illustrated in FIG. 15. In the present embodiment, since the medicine supply apparatus 101 includes two drums 20, there are two buttons 65 and 66 illustrated in the drawing. The button 65 labeled with a letter “L” corresponds to the drum 20 on the left side, and the button 66 labeled with a letter “R” corresponds to the drum 20 on the right side. T user may press one of the buttons 65 and 66 so as to rotate the corresponding drum 20 at a predetermined angle in a predetermined direction. The “predetermined angle” may be an angle corresponding to, for example, one medicine accommodation unit 31. The “predetermined angle” may be an angle corresponding to, for example, a number of m (m is an integer of 2 or more) medicine accommodation units 31. Further, a button 67 is displayed at the lower part of FIG. 15. The button 67 is configured to switch the medicine supply apparatus to a cleaning mode. The cleaning mode may be referred to as the “maintenance mode”, for example. In the present embodiment, the cleaning mode is called as a “first mode”. When the user presses the button 67, the medicine supply apparatus is switched to the first mode, and the input unit 51 is as that illustrated in FIG. 16.

In the present embodiment, the medicine supply apparatus 101 includes two drums 20 and each drum 20 is composed of four segments 30, and thus, a total of eight buttons labeled as L1 to L4 and R1 to R4 are displayed on the display 51a in FIG. 16. L1 to L4 correspond to the four segments 30 included in the drum 20 on the left side, and R1 to R4 correspond to the four segments 30 included in the drum 20 on the right side. Hereinafter, the description will be carried out by taking the drum 20 on the left side as an example. The buttons 61 to 64 corresponding to L1 to L4 are provided on the display 51a, and when either one of them is pushed by the user, the drive unit 52 is driven so as to locate the selected segment 30 at the cleaning position 21. If the selected segment 30 is not at the cleaning position 21, the drum 20 is rotated by a required angle. The user may press any one of the buttons 61 to 64 to rotate the drum 20 illustrated in any one of FIGS. 11 to 14 so as to locate a desired segment 30 at the cleaning position.

Hereinafter, the basic configuration of the medicine supply apparatus according to the present embodiment will be summarized by using the medicine supply apparatus 101 as an example. The medicine supply apparatus 101 includes a housing 2, first to nth segments 30 arranged in the housing 2 along the circumferential direction so as to surround the center line 81 extending in the vertical direction, a drive unit 52 configured to rotate an aggregate of the first to nth segments 30 about the center line 81, an input unit 51 configured to receive an instruction, and a control unit 53 configured to control the drive unit 52. The housing 2 is provided with a cleaning position 21 that allows at least one of the first to nth segments 30 to be cleaned, and each of the first to nth segments 30 includes a plurality of medicine accommodation units 31 configured to accommodate therein a medicine. The input unit 51 is configured to receive an instruction for selecting one of the first to nth segments 30. The control unit 53 is configured to cause the drive unit 52 to locate the selected segment 30 at the cleaning position 21 on the basis of the instruction for selecting one of the first to nth segments 30.

In the present embodiment, by inputting an instruction for selecting one of the first to nth segments 30 to be cleaned from the input unit 51, the selected segment 30 will be automatically rotated to the cleaning position 21, which makes it possible to minimize the waiting time for rotating the drum 20 for cleaning. There is no need for the user to worry about the current orientation of the drum 20, it is only necessary to select and input a segment 30 to be cleaned.

### Second Embodiment

A medicine supply apparatus according to a second embodiment of the present invention will be described. The configuration of the medicine supply apparatus according to the present embodiment is more preferable than the basic configuration described in the first embodiment. The medicine supply apparatus according to the present embodiment further includes a preferable configuration to be described later in addition to the basic configuration described in the first embodiment. Similar to the first embodiment, the present embodiment will be described by using the medicine supply apparatus 101 as an example.

In the medicine supply apparatus 101, n is an integer of 3 or more, when rotating the first segment 30 located at the cleaning position 21 so as to locate the nth segment 30 at the cleaning position 21 or rotating the nth segment 30 located at the cleaning position 21 so as to locate the first segment 30 at the cleaning position 21, the second segment 30 is firstly rotated to pass the cleaning position, and the control unit 53, when activated, causes the drive unit 52 to operate so as to locate the first segment or the nth segment 30 at the cleaning position 21. In the exemple illustrated in FIGS. 11 to 14, n=4. The segments 30 labeled with A, B, C and D correspond to the first to fourth segments 30 in order.

In the state illustrated in FIG. 11, the first segment 30 is located at the cleaning position 21. By rotating the drum 20 in this state counterclockwise by about 90°, it is possible to shift the drum from the state of FIG. 11 to the state of FIG. 12. In FIG. 12, the segment 30 labeled with B, i.e., the second segment 30 is located at the cleaning position 21.

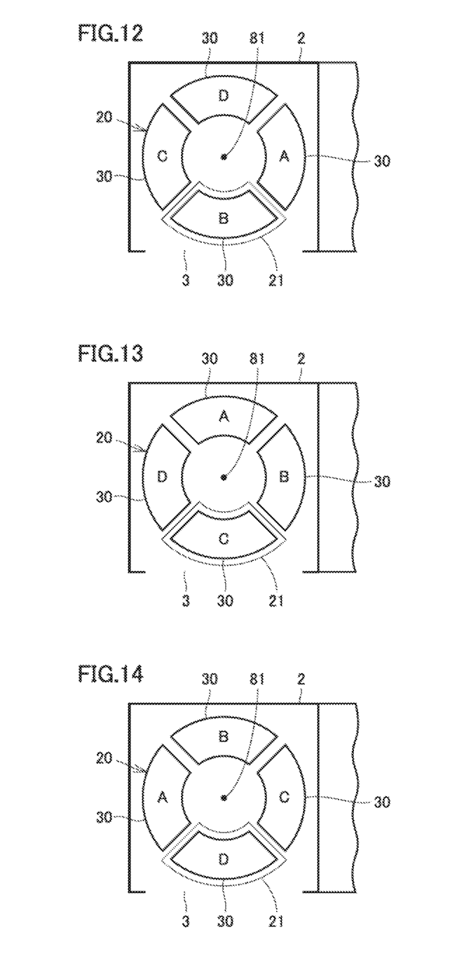

By further rotating the drum 20 illustrated in FIG. 12 counterclockwise by about 90°, it is possible to shift the drum to the state of FIG. 13. In FIG. 13, the segment 30 labeled with C, i.e., the third segment 30 is located at the cleaning position 21.

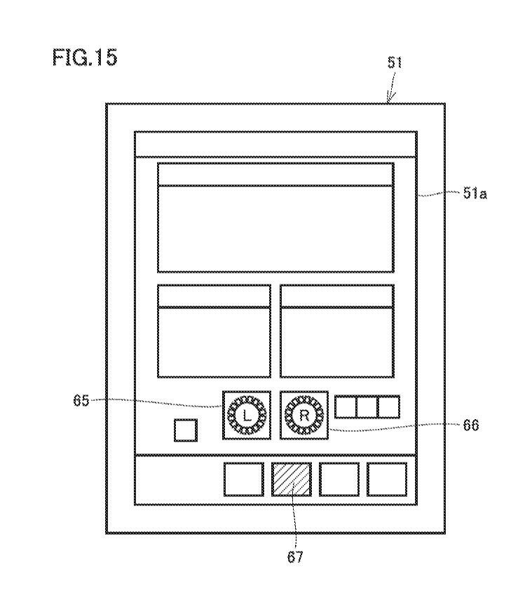

By further rotating the drum 20 illustrated in FIG. 13 counterclockwise by about 90°, it is possible to shift the drum to the state of FIG. 14. In FIG. 14, the segment 30 labeled with D, i.e., the fourth segment 30 is located at the cleaning position 21. Since in the present embodiment n=4, the segment 30 labeled with D corresponds to the nth segment.

It seems that the state of FIG. 14 may be shifted to the state of FIG. 11 by further rotating the drum counterclockwise by about 90°, but the drum 20 is not allowed to be rotated counterclockwise any more. In order to shift the state where the fourth segment 30 is located at the cleaning position 21 as illustrated in FIG. 14 to the state where the first segment 30 is located at the cleaning position 21 as illustrated in FIG. 11, instead of rotating the drum 20 counterclockwise by about 90°, the drum 20 has to be rotated by about 270° clockwise. In other words, the state of FIG. 14 has to be shifted to the state of FIG. 11 through the intermediary of the state of FIG. 13 and the state of FIG. 12.

Since the drum 20 is connected by, for example, various wires, if the drum 20 is rotated by a very large angle in one direction, the wires will be twisted, which causes excessive load to the wires or any components surrounding the wires. Therefore, in order to avoid such a situation, the angle by which the drum 20 may rotate is limited. The reason for limiting the rotatable angle may be another reason other than the twisting of wires. Here, the example has been described when n=4, it should be noted that n may be any integer of 3 or more.

In the medicine supply apparatus according to the present embodiment, the rotation angle of the drum 20 is limited as described above. In the medicine supply apparatus according to the present embodiment, the control unit 53, when activated, causes the drive unit 52 to operate so as to locate the first segment or the nth segment 30 at the cleaning position 21.

In the present embodiment, after the control unit 53 is activated, the first segment or the nth segment 30 is automatically located at the cleaning position 21, which makes the subsequent cleaning operation to be performed smoothly. Since either the first segment or the nth segment 30 is located at the cleaning position 21, by rotating the segments 30 one by one sequentially in a predetermined direction, it is possible to locate all the segments sequentially at the cleaning position 21. Thereby, the cleaning operation may be performed on one segment 30 located at the cleaning position 21. When the cleaning operation is completed, the drum 20 is rotated by a predetermined angle so as to locate the next segment 30 at the cleaning position 21 for cleaning. Thereby, by rotating the drum repeatedly, it is possible to clean all the segments 30, and meanwhile, it is possible to minimize the waiting time for rotating the drum 20 for cleaning.

It is acceptable that the control unit 53, when activated, causes the drive unit 52 to perform an initial operation, and the initial operation is ended when the first segment or the nth segment 30 is located at the cleaning position 21. Thus, the initial operation is performed immediately after the activation, and after the initial operation, the first segment or the nth segment 30 is automatically located at the cleaning position 21, allowing the user to perform the cleaning operation. Thus, if the user wishes to perform the cleaning operation immediately after the activation, he/she may start the cleaning operation smoothly.

As described with reference to FIGS. 15 and 16 in the first embodiment, it is preferable that the input unit 51 is configured to receive an instruction for selecting a first mode, and when the instruction for selecting the first mode is received by the input unit 51, the control unit 53 causes the drive unit 52 to operate so as to locate the first segment or the nth segment 30 at the cleaning position 21. By adopting this configuration, the user may select the first mode at a desired timing not only immediately after the control unit 53 is activated but also when the medicine supply apparatus is in use. After the first mode is selected, the first segment or the nth segment 30 is located at the cleaning position 21 by the control unit 53, allowing the user to start the cleaning operation smoothly.

### Third Embodiment

A medicine supply apparatus according to a third embodiment of the present invention will be described. The medicine supply apparatus according to the present embodiment further includes a preferable configuration in addition to the basic configuration described in the first embodiment. In the present embodiment, the description will be carried out by using the medicine supply apparatus 101 as an example.

In the medicine supply apparatus 101, n is an integer of 3 or more, when rotating the first segment 30 located at the cleaning position 21 so as to locate the nth segment 30 at the cleaning position 21 or rotating the nth segment 30 located at the cleaning position 21 so as to locate the first segment 30 at the cleaning position 21, the second segment 30 is firstly rotated to pass the cleaning position 21, the input unit 51 is configured to receive an instruction for selecting a first mode, and when the instruction for selecting the first mode is received by the input unit 51, the control unit 53 causes the drive unit 52 to operate so as to locate the first segment or the nth segment 30 at the cleaning position 21.

It is not necessary for the present embodiment to perform those operations immediately after the activation as described in the second embodiment, in other words, it is not necessary for the medicine supply apparatus of the present embodiment to include the configuration described in the second embodiment.

In the present embodiment, the user may select the first mode at a desired timing, and after the first mode is selected, the first segment or the nth segment 30 is located at the cleaning position 21 by the control unit 53, allowing the user to start the cleaning operation smoothly. Thus, it is possible to minimize the waiting time for rotating the drum 20 for cleaning.

It is preferable that in any of the first to third embodiments, the control unit 53 is configured to cause the drive unit 52 to operate so as to locate the segments 30 at the cleaning position 21 one by one sequentially. It is preferable that the medicine supply apparatus 101 is provided with the buttons 65 and 66 in the input unit 51, and the user may press one of the buttons 65 and 66 to rotate the selected drum 20 by a predetermined angle. Although the description has been carried out by assuming that the medicine supply apparatus is provided with two drums 20, the same applies to a medicine supply apparatus provided with only one drum 20 or a medicine supply apparatus provided with three or more drums.

Note that the embodiments described above may be combined appropriately where necessary.

It should be understood that the embodiments disclosed herein have been presented for the purpose of illustration and description but not limited in all aspects. It is intended that the scope of the present invention is not limited to the description above but defined by the scope of the claims and encompasses all modifications equivalent in meaning and scope to the claims.

### REFERENCE SIGNS LIST

2: housing; 3: opening; 4: front plate; 5: top plate; 6a, 6b: door; 7: plate; 7a: opening; 8: side plate; 11: pillar; 16a, 16b: handle; 20: drum; 21: cleaning position; 22: annular member; 23: connection member; 24: bottom plate; 25: axial passage; 30: segment; 31: medicine accommodation unit; 32: support member; 34: upper portion; 35: lower portion; 37: radial passage; 38: inclined surface; 39: inner peripheral surface; 40, 43: side face; 42: shaft support; 51: input unit; 51a: display; 52: drive unit; 52a: motor; 52b: gear; 53: control unit; 61, 62, 63, 64, 65, 66, 67: button; 81: center line; 101: medicine supply apparatus

1. A medicine supply apparatus comprising:
a housing;
first to nth (n is an integer of 2 or more) segments which are arranged in order in the housing along the circumferential direction so as to surround a center line extending in the vertical direction;
a drive unit configured to rotate an aggregate of the first to nth segments about the center line;
an input unit configured to receive an instruction; and
a control unit configured to control the drive unit,
the housing being provided with a cleaning position that allows at least one of the first to nth segments to be cleaned,
each of the first to nth segments including a plurality of medicine accommodation units configured to accommodate therein a medicine,
the input unit being configured to receive an instruction for selecting one of the first to nth segments, and
the control unit being configured to cause the drive unit to operate so as to locate the selected segment at the cleaning position on the basis of the instruction for selecting one of the first to nth segments.

2. The medicine supply apparatus according to claim 1, wherein
n is an integer of 3 or more,
when rotating the first segment located at the cleaning position so as to locate the nth segment at the cleaning position or rotating the nth segment located at the cleaning position so as to locate the first segment at the cleaning position, the second segment is firstly rotated to pass the cleaning position,
the control unit, when activated, causes the drive unit to operate so as to locate the first segment or the nth segment at the cleaning position.

3. The medicine supply apparatus according to claim 2, wherein
the control unit, when activated, causes the drive unit to perform an initial operation,
the initial operation is ended when the first segment or the nth segment is located at the cleaning position.

4. The medicine supply apparatus according to claim 2, wherein
the input unit is configured to receive an instruction for selecting a first mode,
when the instruction for selecting the first mode is received by the input unit, the control unit causes the drive unit to operate so as to locate the first segment or the nth segment at the cleaning position.

5. The medicine supply apparatus according to claim 1, wherein
n is an integer of 3 or more,
when rotating the first segment located at the cleaning position so as to locate the nth segment at the cleaning position or rotating the nth segment located at the cleaning position so as to locate the first segment at the cleaning position, the second segment is firstly rotated to pass the cleaning position,
the input unit is configured to receive an instruction for selecting a first mode,
when the instruction for selecting the first mode is received by the input unit, the control unit causes the drive unit to operate so as to locate the first segment or the nth segment at the cleaning position.

6. The medicine supply apparatus according to claim 1, wherein
the control unit is configured to cause the drive unit to operate so as to locate the segments at the cleaning position one by one sequentially.
